(19) United States
(12) Patent Application Publication
(10) Pub. No.: US 2023/0021557 A1
(43) Pub. Date: Jan. 26, 2023

(54) METHOD AND SYSTEM FOR IDENTIFYING TOOLS

(71) Applicant: AIRBUS HELICOPTERS, Marignane Cedex (FR)

(72) Inventors: Serge PITTAU, La Bouilladisse (FR); Philippe TONTIC, Gignac La Nerthe (FR); Franck MARTINO, Port De Bouc (FR)

(73) Assignee: AIRBUS HELICOPTERS, Marignane Cedex (FR)

(21) Appl. No.: 17/864,299

(22) Filed: Jul. 13, 2022

(30) Foreign Application Priority Data
Jul. 22, 2021 (FR) 2107900

(51) Int. Cl. G06K 7/14

(52) U.S. Cl. CPC G06K 7/1447; G06K 7/1456

(57) ABSTRACT

A method and a system for identifying tools intended for tools comprising a marking provided with at least one optically readable symbol. The system comprises, in particular, one or more image capture devices covering a checking area and a calculator. Several tools are positioned by an operator in the checking area, then an image of the checking area is captured by each image capture device. Next, at least one complete symbol is detected in at least one image by an image processing operation carried out by the calculator, and one or more detected tools corresponding respectively to a detected complete symbol are identified. Finally, a list comprising each detected tool is determined.

### CROSS REFERENCE TO RELATED APPLICATIONS

This application claims priority to French patent application No. FR 2107900 filed on Jul. 22, 2021, the disclosure of which is incorporated in its entirety by reference herein.

### TECHNICAL FIELD

The present disclosure relates to the industrial field and, more specifically, to the fields of the production and maintenance of mechanical systems. The present disclosure may also be extended to other fields, such as the medical field, for example.

The present disclosure relates to a method for identifying tools comprising at least one optically readable symbol and a system for identifying such tools.

### BACKGROUND

The industrial field may require tools of various shapes and sizes to be used, such as, for example, screwdrivers, spanners and cylindrical sockets or screwdriver bits. Such tools are used, for example, in the field of the production and the maintenance of mechanical systems, in particular in the motor vehicle and aeronautical fields.

One risk involved when using such tools is that of losing or forgetting a tool in the mechanical system on which an operator is working. The presence of such a tool in a mechanical system may cause damage to the mechanical system and/or impair its operation.

When assembling or repairing a mechanical system, this risk may be increased when a large number of tools of varying shapes and sizes is used.

Solutions are available to prevent tools from being lost.

However, such solutions are not always easy to implement, especially for small tools, yet it is these small tools that present the greatest risks. Indeed, after performing an intervention on a mechanical system, for example, it is easier to forget a small tool than a large tool.

One protection solution consists, for example, of a toolbox or tool cabinet arrangement designed to facilitate visual checks to ensure the presence of the tools. This arrangement may consist in producing pre-cut slots designed to fit the shape of each tool. The bottom of these slots may also be of a different color to the front surface so as to allow the absence of a tool to be detected quickly with a simple glance. However, this solution has some disadvantages. In particular, it provides no certainty that a tool that is missing was present in the box prior to the intervention. Moreover, a tool belonging to another box may also occupy the place of a tool that has been forgotten without this being detected by an operator.

Another protection solution may comprise the individual and unique identification of each tool by labelling or engraving, for example a barcode or any other identification method. This solution involves a restrictive procedure requiring the operator to systematically check the identification of each of the tools at the start and end of the intervention, possibly checking them off on a list drawn up in advance. This procedure, which may be time-consuming when there is a large number of tools, is also dependent on the operator's attention.

Another protection solution consists in using a toolbox referred to as a “smart” toolbox.

A smart toolbox may, for example, be equipped with an optical device and an image analysis system that automatically acquires images when each drawer is opened and closed in order to permanently compare these two images. Since each tool has a specific slot, the system permanently has a precise overview of the tools that are present and the tools that are absent. However, since the tools are not identified individually, this system is not able to distinguish between two tools that are visually similar in terms of shape, color and dimensions, for example an 8 mm socket and a 9 mm socket, or two identical tools from two different boxes, and an incorrect conclusion may therefore result.

A smart toolbox may also be equipped with a contactless reading device, for example using RFID (Radio Frequency Identification) technology. This technology uses waves to read, without contact, information contained in a compatible electronic tag, for example adhered to each tool. A smart toolbox equipped with an RFID reader system can thus automatically check the presence or absence of tools comprising an electronic RFID tag in which the identity of the tool has previously been recorded. Each tool comprising an electronic RFID tag is serialised, i.e., it has an individual and unique identification.

However, the reading distance of the electronic RFID tag is proportional to the size of this electronic RFID tag. As a result, in order to remain readable in toolboxes, the minimum dimensions of these electronic RFID tags are of the order of 5×5×10 mm, thus making them unsuitable for small tools, for example such as sockets, drill bits, screwdriver bits, etc.

Document EP 2 309 420 describes a system and a method for improving the recognition of multiple barcodes with an associated apparatus, by means of image processing. This system analyzes several successive images of barcodes in order, firstly, to determine the type of barcode and, secondly, to identify it.

Document US 2018/0225949 describes a device for detecting items missing from a container such as a bag, a suitcase, a tool belt, or a vehicle, for example. This device identifies items present in the container, compares them with a list of expected items, and issues an alert if at least one expected item is missing. The detection device may comprise a camera. An item may be identified by an RFID chip, a barcode or a QR code. An item may also be identified by its shape, following image analysis and shape detection, or by its mass.

Document WO 2014/167252 describes a surgical instrument traceability and monitoring device, whereby an instrument can be characterized by its shape, after processing an image of the instrument, and by its mass. These characteristics can be compared with a pre-established database in order to identify this surgical instrument. The instruments may be placed on a backlit platform in order to highlight their shape and outline.

Document US 2010/0217678 describes a system for visual recognition of products at a checkout in order to update a stock database, for example. This system may comprise one or more cameras and one or more barcode readers. This system also comprises a lighting system facilitating the identification of the products. Each product may be identified based on its dimensions and its shape determined by analyzing the captured images and/or by a barcode read by at least one barcode reader. The product can be identified by comparing it with a database.

Document U.S. Pat. No. 4,982,627 describes a system for identifying various tools by virtue of markings, in particular a color code provided with a series of engraved and colored grooves extending around the whole circumference of the tool.

Document US 2013/0091679 describes a system intended for the identification and assembly of medical instruments. This system is used to capture images of the instruments by means of at least one camera and compare them with image data recorded in a database in order to identify the medical instruments. The instruments are identified based on their shape, without them carrying an identification means, such as a code or a chip. The system may comprise scales for checking the mass of all of the instruments that are present.

Documents JP 2007-226488 and US 2016/0179909 form part of the technological background of the disclosure.

### SUMMARY

The aim of the present disclosure is therefore to propose an alternative detection and identification method and device suitable for small tools.

The object of the present disclosure is, for example, a method for identifying tools intended to detect and identify tools and a system for identifying tools as claimed.

First and foremost, the object of the present disclosure is a method for identifying tools, the tools comprising a marking provided with at least one optically readable symbol. Such a symbol may be unidirectional, for example a barcode, or indeed bi-directional, for example a matrix code, also referred to as a “two-dimensional barcode”. There are different types of codes within the matrix code family, for example “Data Matrix” codes or “QR codes”.

The method according to the disclosure is remarkable in that it includes the following steps:

positioning several tools in a checking area;

capturing at least one image of the checking area by means of at least one image capture device, said at least one image capture device covering the checking area;

detecting at least one complete symbol situated in said at least one image by means of an image processing operation carried out by a calculator;

identifying, with the calculator, at least one detected tool corresponding to said at least one complete symbol detected during the detection; and

determining a list comprising each detected tool of said at least one detected tool.

Therefore, the method according to the disclosure makes it possible to simultaneously identify all of the tools present in the checking area by means of their optically readable symbol.

The tools are positioned in the checking area by an operator, without taking any particular precautions. The checking area may be on a table or a work surface, the checking area being situated, for example, under said at least one image capture device. The symbol of each tool positioned in the checking area is thus present in the images captured by the image capture device or devices.

Said at least one image capture device may comprise, for example, at least one photographic device or indeed a camera. Said at least one image capture device may capture images in the range visible to the human eye and/or in the infrared range and/or in the ultraviolet range, for example. Said at least one image may be recorded in a memory connected to the calculator or in a memory of the calculator.

The calculator then applies an image processing algorithm in order to firstly detect each complete symbol present in said at least one image and secondly identify each tool present in the checking area by virtue of each complete symbol detected in said at least one image. The image processing algorithm may be stored in a memory connected to the calculator or in a memory of the calculator.

Each optically readable symbol comprises a numeric or alphanumeric reference with which a tool is associated. This numeric or alphanumeric reference is represented, for example, in the form of a barcode or a matrix code. Preferably, a single tool is associated with a single reference and therefore with a single optically readable symbol. For example, two identical tools are associated with two different references and, therefore, with two different symbols.

The association between the tools, the numeric or alphanumeric references and, consequently, the optically readable symbols may be in the form a model comprising a list, a table, a database or any other means which associates the tools and the references. This model is stored, for example, in a memory connected to the calculator or in a memory of the calculator.

This method ultimately makes it possible to determine the list of tools detected in the checking area. Two lists may thus be established respectively before an intervention on a mechanical system by the operator and after this intervention on the mechanical system, making it possible, in particular, to identify if one or more tools have potentially been forgotten in the mechanical system, by making a comparison.

The method according to the disclosure may comprise one or more of the following features, taken individually or in combination.

For example, the marking on the tools covers 360° in a peripheral region of the tool.

According to a first variant, the marking may comprise a single unidirectional symbol imprinted continuously on the marking and, therefore, in the peripheral region of the tool. This unidirectional symbol is, for example, a barcode whose bars are therefore imprinted continuously over 360° in the peripheral region of the tool.

According to a second variant, the marking may comprise several identical symbols that may or may not be separated by a space, in the peripheral region. The symbols are then imprinted discontinuously in the peripheral region. The space that may be left between two symbols does not comprise any marks, for example, thus making it easier to identify the edges of each of the symbols. The symbol may be unidirectional, for example a barcode, or indeed bi-directional, for example a matrix code.

According to this second variant, the symbols may be imprinted on the tool in a single row or indeed in several rows. The symbols may possibly be angularly offset from row to row in the peripheral region when the marking comprises several rows of symbols.

Moreover, when the peripheral region of the tool comprises several faces, at least one symbol may be imprinted on each face. The peripheral region of the tool may also be cylindrical, for example when it is situated on a screwdriver shank or indeed on a drill bit.

Therefore, regardless of the variant, at least one symbol imprinted on the tool is in the capture field of said at least one image capture device, irrespective of its position and orientation. At least one symbol of each tool may consequently be present in said at least one image captured by said at least one image capture device, thus allowing the simultaneous detection of at least one symbol per tool, and simultaneous identification of all the tools present in the checking area.

The dimensions of a symbol may, for example, be 15 mm long for a unidirectional symbol such as a barcode. The height of this unidirectional symbol may range from 1 mm, for example in order to allow it to be read, to covering the entire periphery of a tool, so as to make it easier to detect and identify with the method according to the disclosure.

A symbol may, for example, be in the form of a square measuring 5 mm by 5 mm, or a rectangle measuring 5 mm by 10 mm in the case of a bi-directional symbol such as a matrix code.

These examples of dimensions of unidirectional and bi-directional symbols may, for example, comprise a reference represented in the form of a barcode or a matrix code. This reference may consist, for example, of at least four characters, where a character may be a number or a letter. Four-character references generally provide a high enough number of combinations to individually and uniquely identify all of the small and medium-sized tools that may be used for interventions on a mechanical system, for example an aircraft.

Moreover, the marking may have a matted area on which the symbol or symbols are imprinted. Such a matted area helps limit the presence of reflections on the marking or reduce the effects of glare and thus improve the visibility of the symbol in said at least one image and, therefore, facilitate the identification of the tool.

This matted area may be obtained in a conventional manner by abrasion of an area intended for marking on the tool, for example by sandblasting. However, this sandblasting operation requires the surfaces of the tool that are not to be matted to be protected. Moreover, sandblasting may degrade or even remove a surface or protective treatment of the tool protecting it against certain phenomena, for example corrosion.

Advantageously, this matting may be achieved by means of a laser beam scanning over the area to be matted. The imprinting of said at least one symbol on the area matted in this way is also achieved by the beam, which allows this to be carried out following on from the matting operation, with the same means, the laser beam, and without removing the tool. The time required to carry out the matting operation and mark the tool is thus reduced and optimized.

A method for marking the tool may therefore comprise the following steps:

matting an area intended for marking on the tool by means of a laser beam; and

marking at least one symbol on the matted area by means of the laser beam.

The matting is thus carried out by a first pass of the laser beam and the marking of said at least one symbol is carried out by a second pass of the laser beam. The matting is carried out with the laser beam used at very low energy, emitting less energy than for the marking, i.e., at a lower power or at a faster scanning speed than for the marking.

As already mentioned, the marking step may comprise imprinting a single unique symbol in a continuous manner in the peripheral region of the tool or indeed imprinting several symbols in a discontinuous manner on this peripheral region.

According to another example, the method may comprise a step of recording the list of tools in a memory connected to the calculator after this list has been determined. This recording makes it possible, for example, to subsequently use this list as a reference list in order to check that no tool has been forgotten.

According to another example, at least two image capture devices together cover the checking area, each image capture device covering a capture area, the checking area being equal to the surface area covered together by the capture areas of said at least two image capture devices, and the capture areas of said at least two image capture devices have an overlap area with a width greater than or equal to the largest dimension of a symbol.

Therefore, any symbol situated at least partially on the overlap area is present, fully and completely, on at least one image captured by one of the at least two image capture devices. Any symbol may therefore be detected and the associated tool may be identified.

As a result, the tools present in the checking area can thus be detected and identified by means of their symbols from a single image captured by each image capture device.

According to another example, the method may comprise a step of illuminating the checking area. This illumination helps ensure that all the tools and all the symbols are clearly visible in said at least one image. This illumination makes it possible, in particular, to illuminate a symbol of a tool that may be in the shadow of another tool, in particular a larger tool.

To this end, an illumination device may for example be positioned between said at least one image capture device and the checking area. This illumination device may comprise one or more light sources, for example light-emitting diodes.

According to another example, the method may comprise the following steps:

comparing, with the calculator, the list comprising each detected tool with a previously established reference list; and

issuing an alert if the list of detected tools is different from the reference list.

The reference list has, for example, been determined in advance and recorded by means of the method according to the disclosure before the operator intervenes on the mechanical system.

An alert, which may be visual or audible, for example, is issued if the lists do not comprise the same tools. In particular, the list of detected tools may comprise fewer tools than the reference list, at least one tool therefore having potentially been forgotten in the system or in the vicinity. The list of detected tools may also comprise more tools than the reference list if tools from another operator have been taken by the operator. The list of detected tools may also comprise the same number of tools as the reference list, in which case some tools have been swapped with those of another operator.

The alert may then only indicate a difference, without any other details, the alert then being in the form of a sound being emitted or an indicator light illuminated, for example in red. The sound or the indicator light may also allow the type of differences to be identified, i.e., one or more missing tools, one or more surplus tools or one or more swapped tools.

The alert may also be in the form of a message displayed on a screen, indicating the type of differences, i.e, one or more missing, surplus or swapped tools.

The method may also comprise displaying a piece of information relating to this comparison, in particular when the lists are identical, for example by illuminating a green indicator light or displaying a specific message.

According to another example, the method may comprise the following steps:

measuring a first mass of said at least one tool positioned in the checking area by means of scales;

calculating a second mass equal to the sum of the theoretical masses of the tools present in the list with the calculator, each tool being associated with a theoretical mass;

comparing the first mass and the second mass; and

issuing an alert if a difference between the first mass and the second mass is greater than a predetermined threshold.

Therefore, as well as the symbol-based identification operation, an additional check is carried out based on the mass of each tool. The mass of all the tools present in the checking area, the checking area being formed in this scenario by all or part of the weighing pan of the scales, is in this case compared with the sum of the theoretical masses of all the tools identified by the method according to the disclosure.

A theoretical mass is associated with each tool and therefore with the symbol of each tool, for example in a list, a table, a database or any other means, and is for example stored in a memory connected to the calculator.

If the first mass differs significantly from the second mass, i.e., by a value greater than a predetermined threshold, at least one tool has not been identified or has been incorrectly identified. This predetermined threshold takes into account the accuracy of the scales and, possibly, the mass of any grease, sealing compound or dirt that may be present on the tools, for example. This predetermined threshold must be lower than the mass of the lightest tool that may be used. The predetermined threshold is equal to 1 gram, for example.

Such a difference between the first and second masses may be due to a tool not being identified, if its symbol is at least partially, or indeed completely, concealed by another tool, for example, or if the symbol has been at least partially, or indeed completely, damaged or erased.

A tool may also be incorrectly identified if the symbol is damaged in such a way as to resemble the symbol of another tool.

The alert may be visual or audible and be in the form, for example, of a sound being emitted or a red indicator light illuminated. The alert may also be in the form of a message displayed on a screen, indicating the difference in mass between the first and the second masses.

The method may also comprise displaying a piece of information relating to the comparison between the first and second masses. This step may comprise, for example, illuminating a green indicator light or displaying a specific message when the difference between them is less than or equal to the predetermined threshold.

The object of the present disclosure is also a system for identifying tools comprising:

at least one image capture device, said at least one image capture device covering a checking area; and

a calculator.

The system for identifying tools is configured to implement the previously described method for identifying tools.

The system for identifying tools may also comprise an illumination device positioned between said at least one image capture device and the checking area, this illumination device being able to comprise one or more light sources.

The system for identifying tools may further comprise scales fitted with a weighing pan, the checking area being situated on the weighing pan of the scales.

The system for identifying tools may comprise the previously described tools, the marking of which is arranged, for each tool, over 360° in a peripheral region of the tool.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a perspective view of a system for identifying tools according to the disclosure;

FIG. 2 is a side view of the system for identifying tools;

FIG. 3 is an overview diagram of a method for identifying tools;

FIG. 4 is a view of the checking area comprising tools;

FIG. 5 is a view of the checking area comprising tools stored in a box;

FIG. 6 is a simplified view of the checking area;

FIG. 7 is a view of a tool with a marking according to the prior art;

FIG. 8 is a view of a tool with a marking according to the disclosure;

FIG. 9 is a view of a tool with a marking according to the disclosure; and

FIG. 10 is an overview diagram of a method for marking a tool.

### DETAILED DESCRIPTION

Elements that are present in more than one of the figures are given the same references in each of them.

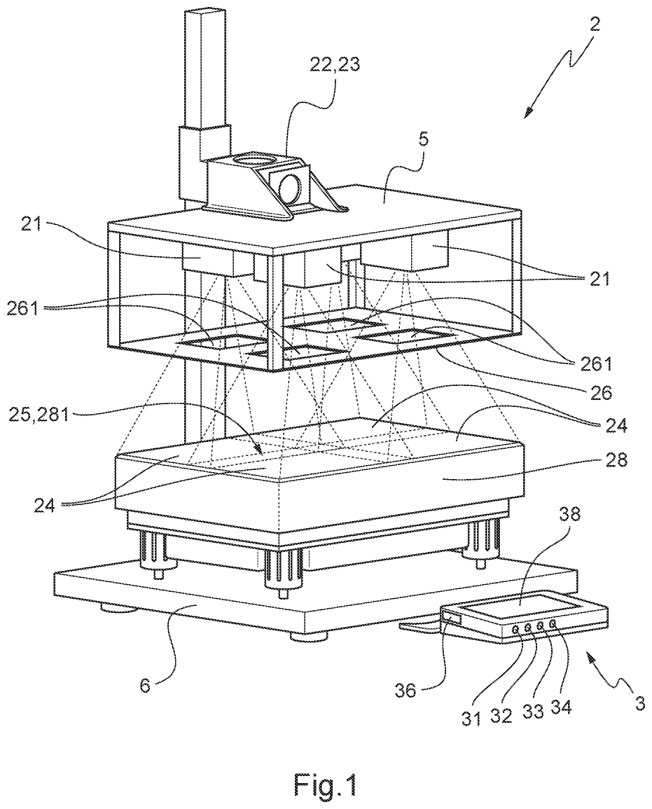

FIG. 1 shows a system 2 for identifying tools comprising at least one image capture device 21 and at least one calculator 22. Said at least one image capture device 21 covers a checking area 25 in which tools 1 comprising a marking 11 can be placed. Each marking 11 is provided with at least one symbol 15 for identification purposes. An image capture device 21 may comprise a camera or a photographic device.

The example of the system 2 for identifying tools shown in FIG. 1 comprises four image capture devices 21. Each image capture device 21 covers a capture area 24, individually and respectively, such that the four image capture devices 21 together cover the checking area 25 formed by the combination of the four capture areas 24.

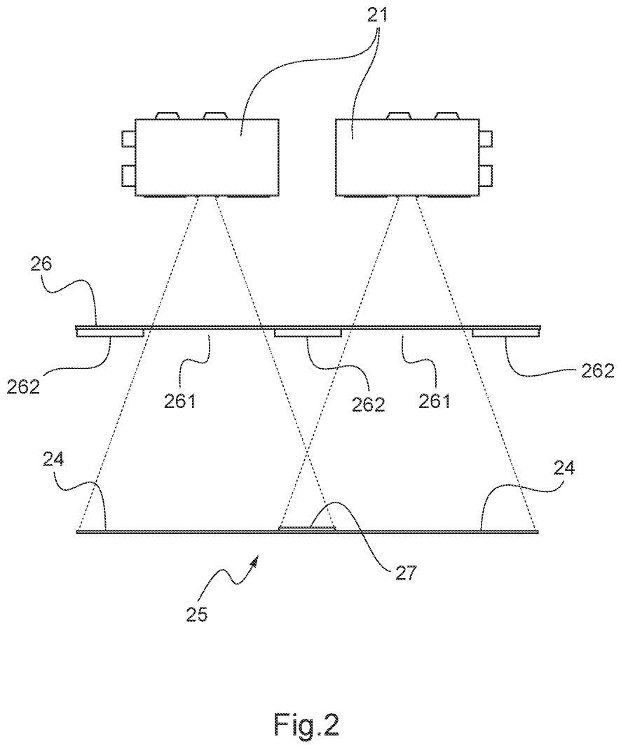

Two adjacent capture areas 24 intersect in order to avoid the presence of areas not covered by at least one image capture device 21, as shown in FIG. 2.

Each image capture device 21 is positioned in such a way as to capture an image comprising at least part of the checking area 25. When the system 2 for identifying tools comprises a single image capture device 21, the latter is positioned in such a way as to capture an image comprising the checking area 25 in its entirety. Each image capture device 21 is for example positioned above the checking area 25 and may be fastened to a structure 5, this structure 5 being able to be placed on or fastened to a table 6 or a work surface 6.

For example, the calculator 22 may comprise at least one processor and at least one memory 23, at least one integrated circuit, at least one programmable system, or at least one logic circuit, these examples not limiting the scope to be given to the term “calculator”. The term “processor” may refer equally to a central processing unit (CPU), a graphics processing unit (GPU), a digital signal processor (DSP), a microcontroller, etc.

The system 2 for identifying tools may also comprise a memory 23 connected to the calculator 22 via a wired or wireless link. Moreover, the calculator 22 is connected to each image capture device 21 via a wired or wireless link such that each image capture device 21 can transmit the captured images to the calculator 22, by means of an optical or electrical signal, in analog or digital form. Moreover, a calculator may be integrated into each image capture device 21.

The system 2 for identifying tools may also comprise an interface 3 that may comprise control buttons 31, 32, indicator lights 33, 34, a loudspeaker 36 and/or a screen 38.

The system 2 for identifying tools may also comprise an illumination device 26 for illuminating the checking area 25. This illumination device 26 may comprise one or more light sources 262 for illuminating the checking area 25. A light source 262 may, for example, be a light-emitting diode or a tubular low-pressure discharge lamp also referred to as a “fluorescent tube”. The illumination device 26 is, for example, fastened to the structure 5.

The illumination device 26 is, for example, positioned between the image capture devices 21 and said checking area 21, as shown in FIGS. 1 and 2. The illumination device 26 then comprises one or more openings 261 to allow the capture area 24 of each image capture device 21 to cover at least part of the checking area 25, such that the checking area 25 is entirely covered by the combination of these capture areas 24.

The system 2 for identifying tools may also comprise scales 28. The scales 28 are positioned under the image capture device or devices 21 such that the checking area 25 is located on the weighing pan 281 of the scales 28. The checking area 25 may cover all or part of the weighing pan 281.

The scales 28 may be placed on the table 6 to which the structure 5 is fastened. The structure 5 may optionally be fastened to the scales 28, for example to a frame or framework of the scales 28, possibly instead of being fastened to the table 6.

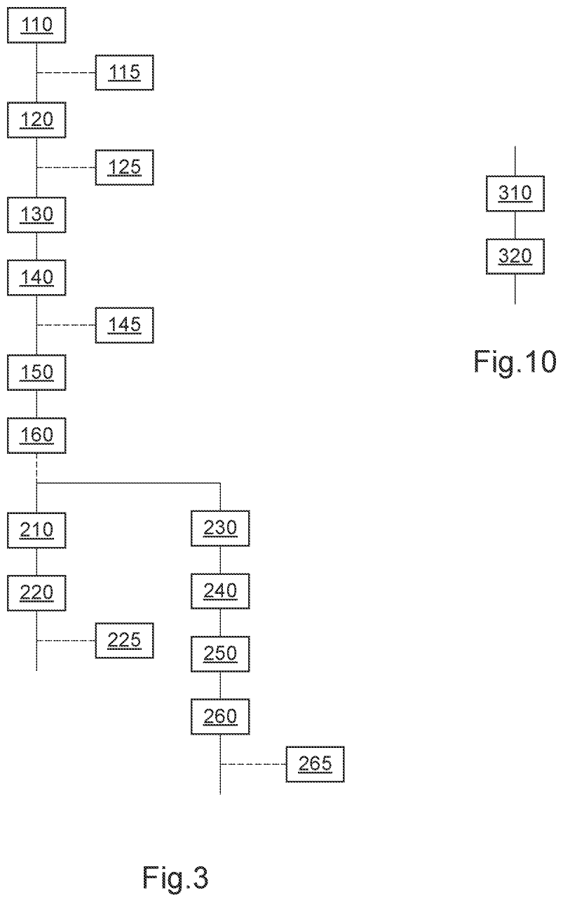

The system 2 for identifying tools is configured to implement a method for identifying tools 1, an overview diagram of which is shown in FIG. 3. The memory 23 may store an algorithm for carrying out such a method for identifying tools.

The method for identifying tools comprises the following steps.

First, a step 110 of positioning several tools 1 in the checking area 25 is carried out, an operator positioning the tools 1 in the checking area 25, for example.

When the operator has positioned all the tools 1 in the checking area 25, he or she may optionally actuate a control button 31 on the interface 3 in order to continue or initiate the method for identifying tools according to the disclosure.

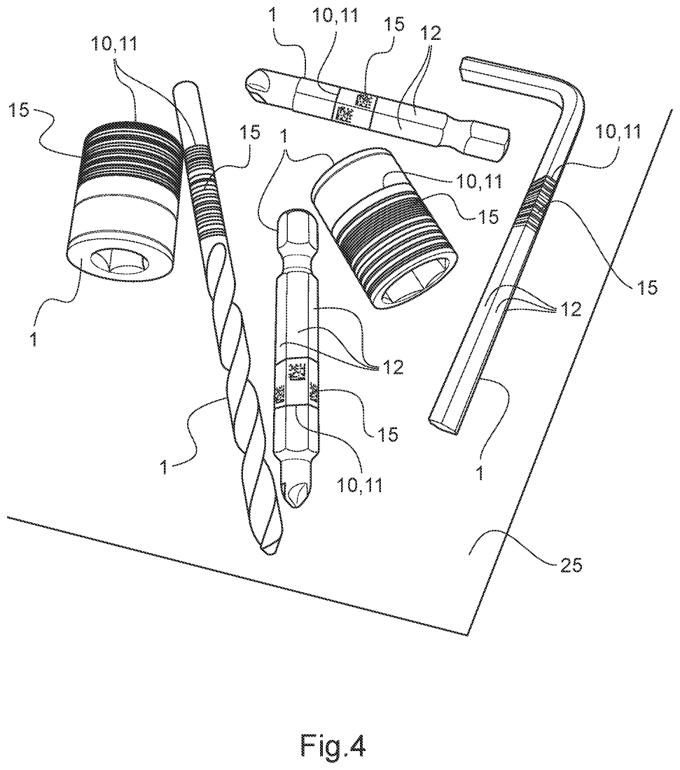

The tools 1 may be positioned randomly and without taking any particular precaution, as shown in FIG. 4.

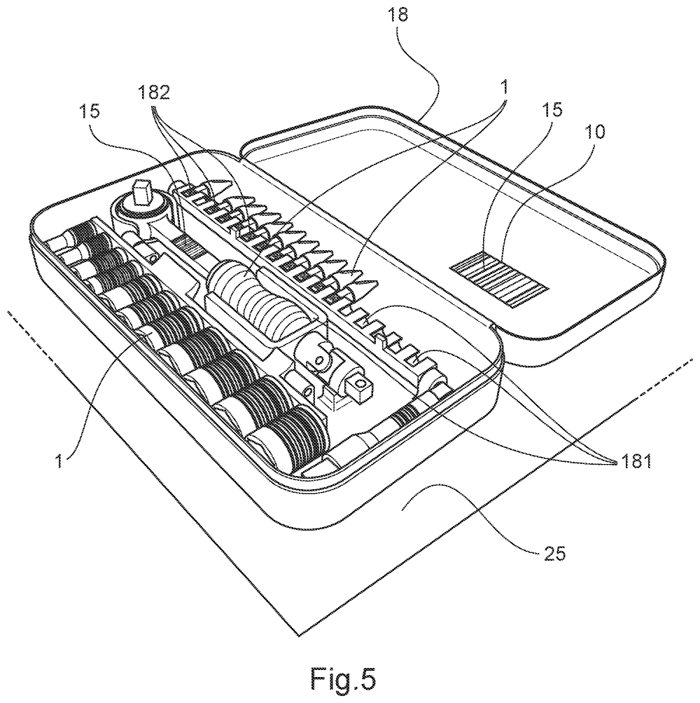

The tools 1 may also be positioned in the checking area 25 in a storage box 18 comprising a slot 181 designed to fit each tool 1, as shown in FIG. 5.

Each tool 1 comprises a marking 10 provided with at least one symbol 15. Each symbol 15 allows the tool 1 to be identified by optical reading, a reference specific to the tool being defined by the symbol 15. A symbol 15 may be unidirectional, like a barcode, or indeed bi-directional, like a matrix code.

A symbol 15 may allow a tool 1 to be identified irrespective of the operator to whom it belongs or the storage box 18 from which it originates. By way of illustration, the symbols 15 can therefore be used, for example, to identify 8 mm sockets and 9 mm sockets, but two 8 mm sockets will carry the same symbol 15 even if they come from two different storage boxes 18.

A symbol 15 may also allow a tool 1 to be identified individually and uniquely. By way of illustration, the symbols 15 may then be used to identify 8 mm sockets and 9 mm sockets, but also to identify and distinguish between two 8 mm sockets from two different storage boxes 18, these two 8 mm sockets carrying two different symbols 15.

The storage box 18 may comprise, for each slot 181, an opening 182 designed such that at least one symbol 15 of each tool 1 is visible when the tool 1 is stored in a slot 181 designed for it.

Next, a step 120 of capturing at least one image of the checking area 25 is carried out by means of said at least one image capture device 21.

A step 115 of illuminating the checking area 25 may be carried out by means of the illumination device 26. This illumination step 115 may be carried out only during the capturing step 120 or indeed be initiated prior to the capturing step 120 and be kept active during, and after, the capturing step 120. This illumination step may in particular allow the entire checking area 25 and all the tools 1 located in the checking area 25 to be illuminated in a homogeneous and uniform manner, including tools 1 that may be located in the shadow of another tool 1.

A step 130 of detecting at least one complete symbol 15 situated in said at least one image is then carried out by the calculator 22, by means of image processing. This detection step 130 comprises applying a known image processing process in order to detect one or more symbols 15, for example.

If the system 2 for identifying tools comprises a single image capture device 21, a single image is processed by the calculator 22. If the system 2 for identifying tools comprises several image capture devices 21, for example four image capture devices 21, several images are processed by the calculator 22, for example four images.

The method for identifying tools according to the disclosure may possibly comprise an intermediate step 125 of transmitting a signal carrying data of said at least one image from said image capture device 21 to said calculator 22, carried out after the capturing step 120.

Moreover, the calculator 22 may possibly comprise several calculators, one calculator being located in each image capture device 21, for example, when the system 2 for identifying tools comprises several image capture devices 21. The calculator of an image capture device 21 then only processes the image captured by that image capture device 21. Each calculator then transmits the result of this detection 130 to a central calculator of the calculator 22, which may be one of the calculators located in the image capture devices 21 or a dedicated additional calculator.

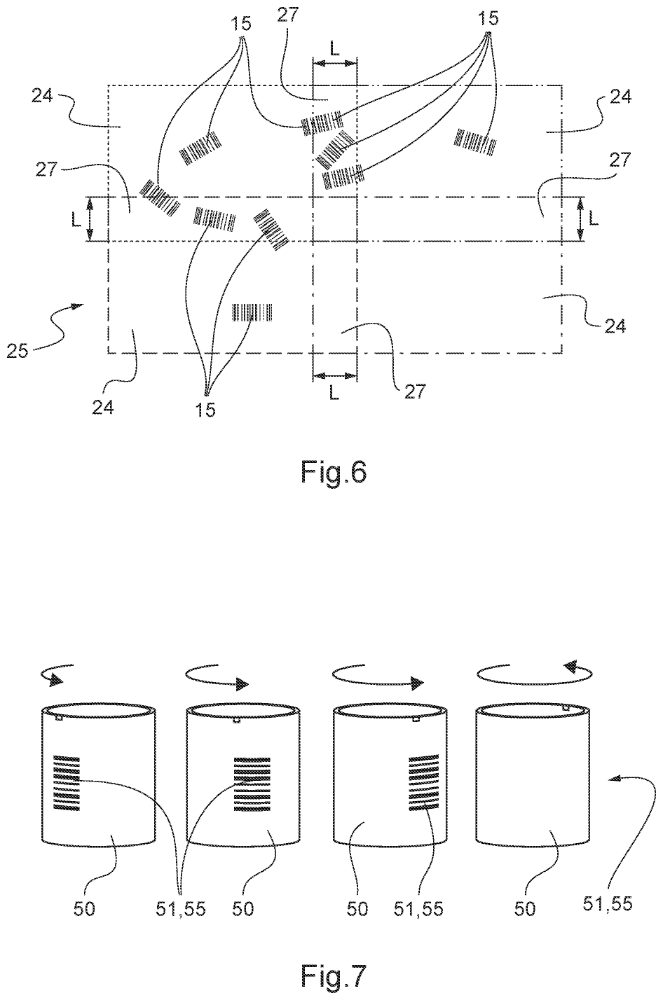

FIG. 6 shows a simplified view of the checking area 25 on which only a symbol 15 is shown for each tool 1, the tools 1 not being shown. The edges of the capture areas 24 of each image capture device 21 and the edges of the checking area 25 are also shown. The checking area 25 is formed by four capture areas 24 in the example shown, and therefore comprises four overlap areas 27 respectively formed by the intersections of two adjacent capture areas 24.

The width L of each overlap area 27 is advantageously greater than the largest dimension of each symbol 15.

As a result, it can be seen that the symbols 15 that are situated partially in an overlap area 27 are present in a first capture area 24, and therefore in a first captured image, in an incomplete manner, and also in a second capture area 24, and therefore in a second captured image, fully and completely, and will therefore be correctly detected by the method for identifying tools.

Conversely, the symbols 15 that are situated entirely in an overlap area 27 are present simultaneously in the first and the second capture areas 24, and therefore in the first and the second captured images, fully and completely, and will therefore be correctly detected by the method for identifying tools.

However, correctly detecting the symbols 15 of the tools 1 may be dependent on the orientation of the tools 1 in the checking area 25.

Indeed, when the marking on a tool 50 is limited to a restricted area of its periphery, as shown in FIG. 7, the symbol 55 imprinted on the marking 51 is not always completely visible, and may even be completely invisible, depending on the orientation of the tool 50. In this scenario, it is not possible to detect and identify it.

In the context of the disclosure and in order to facilitate detection of a symbol 15 and, therefore, identification of the tools 1, the marking 10 on the tools 1 may cover 360° in a peripheral region 11 of the tool 1. The peripheral region 11 of a tool 1 may be cylindrical or comprise several faces 12, for example having a triangular, square or hexagonal cross section, for example.

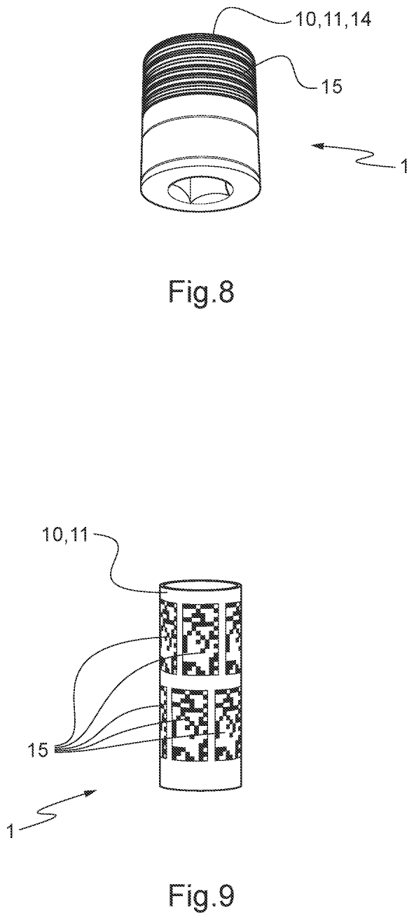

For example, the marking 10 may comprise a single symbol 15 imprinted continuously over 360° in the peripheral region 11, as shown in FIG. 8. The symbol 15 is in this case unidirectional.

According to another example shown in FIG. 9, the marking 10 may comprise several identical symbols 15 separated by a space in the peripheral region 11. The symbols 15 may be unidirectional or bi-directional. The marking 10 may comprise one or more rows of symbols 15 imprinted in the peripheral region 11 of the tool 1. When the marking 10 comprises at least two rows of symbols 15, these symbols 15 may be angularly offset from one row to the next in the peripheral region.

When the peripheral region 11 comprises several faces 12, as shown in FIG. 4, one or more symbols 15, which may either be unidirectional or bi-directional, for example, may be imprinted on each face 12, depending on the dimensions of these faces 12. A symbol 15 may also be imprinted continuously over 360° on these faces 12, in the peripheral region 11, the symbol 15 then being unidirectional.

Therefore, the marking 10 comprising one symbol 15 imprinted in a continuous manner in the peripheral region 11 or several symbols 15 imprinted in a discontinuous manner in this peripheral region 11, at least one symbol 15 or part of a symbol 15 is visible, detectable and identifiable without the operator needing to consider the position and the orientation of the tools 1 in the checking area 25.

Similarly, in the storage box 18, at least one symbol 15 or part of a symbol 15 is visible, through the opening 182 of each slot 181, without the operator positioning or orienting the tools 1 in a particular manner.

Moreover, the marking 10 may have a matted area 14 on which the symbol or symbols 15 are imprinted in order to facilitate identification of the symbol 15 and, therefore, the tool 1, in said at least one image, in particular by limiting the presence of reflections.

In particular, this matted area 14 may be obtained by means of a laser beam scanning over the area to be matted, before said at least one symbol is imprinted in the area 14 matted in this way, by means of the same beam.

To this end, a method for marking the tool may be carried out, an overview diagram of which is shown in FIG. 10.

This method for marking the tool first comprises a step 310 of matting an area intended for the marking 10 of the tool 1 by means of a laser beam.

This method for marking the tool then comprises a step 320 of marking at least one symbol 15 on the matted area 14 by means of the laser beam.

Therefore, these two steps 310, 320 may be carried out following on from each other, without removing the tool 1 and with the same laser beam, thus optimizing the time required for these steps. Moreover, the matting 310 of the tool 1 may be controlled easily by regulating, for example, the energy and/or the scanning speed of the laser beam, and is therefore less aggressive for the tool 1 than matting by sandblasting, for example.

The matting step 310 is carried out, for example, during a first pass of the laser beam carried out over the entire area intended for marking, with the laser beam used at low or very low energy, possibly combined with a very small pitch in order to make the obtained matted area 14 very homogeneous. This matting step 310 is thus carried out without the need to shield or protect regions that are not to be matted, unlike matting by sandblasting, for example. Moreover, this matting step 310 limits or indeed eliminates damage that may affect a surface or protective treatment of the tool 1.

The marking 320 may then be made during a second pass of the laser beam carried out with the laser beam at higher energy in order to engrave the symbol or symbols 15 on the matted area 14 of the tool 1. The marking 320 is thus made with the laser beam used at a power higher than the power of the laser beam for the matting step 310 and/or at a scanning speed slower than the scanning speed of the laser beam for the matting step 310.

Moreover, after the step 130 of detecting at least one complete symbol 15, the method for identifying tools comprises a step 140 of identifying, with the calculator 22, at least one detected tool 1 corresponding to said at least one detected complete symbol 15.

During this identification step 140, the calculator 22 identifies, by means of a suitable and known image processing operation, the reference corresponding to each complete symbol 15 detected in said at least one image. Moreover, each tool 1 being associated with the reference corresponding to the symbol 15 imprinted on the tool 1, the calculator 22 may thus identify each detected tool 1 present in the checking area by means of each complete symbol 15 detected during the detection step 130. This association may be in the form of a model that associates the tools 1 and the references in a list, a table, a database or any other means, stored in the memory 23. This model may also comprise a theoretical mass of each tool 1.

This identification step 140 may comprise a sub-step 145 of deleting duplicates when two identical symbols are detected in an overlap area 27.

Indeed, when a symbol 15 is situated entirely in an overlap area 27, it is simultaneously present in two capture areas 24, and therefore in two captured images. In order to prevent the same tool 1 being identified twice, the sub-step 145 of deleting duplicates makes it possible to take this symbol 15 into account only once, for example by removing it from one of the two captured images, in order to identify this tool 1 only once in this overlap area 27.

This sub-step 145 of deleting duplicates is particularly useful when a symbol 15 identifies a type of tool 1 irrespective of the operator to whom it belongs or the storage box 18 from which it originates, in order to prevent two identical tools 1 from being identified when only one is present in the checking area 25.

Next, a step 150 of determining a list comprising each detected tool 1 from said at least one detected tool 1 is carried out by the calculator 22. This list comprises all the tools 1 detected and identified as present in the checking area 25.

This list of tools may optionally be saved in the memory 23 during a step 160 of recording the list in a memory 23.

The sub-step 145 of deleting duplicates may also be carried out after the determination step 150. Indeed, if a symbol 15 is situated entirely in an overlap area 27 and is therefore simultaneously present in two capture areas 24, and therefore in two captured images, the list of tools may comprise this tool 1 twice. The deletion sub-step 145 therefore allows one instance of this tool 1 to be deleted from this list of tools 1 so that it only appears once in the list of tools.

For example, when the method for identifying tools according to the disclosure is applied before an intervention on a mechanical system by the operator, the list of tools 1 placed in the checking area 25 that is thus established and saved may be used as a reference list to check, after this intervention, that no tool has been forgotten in the mechanical system or in the vicinity of the mechanical system, or swapped with another operator.

To this end, the operator applies the method according to the disclosure after the intervention, this method comprising two additional steps, namely a step 210 of comparing, with the calculator 22, the list established during the determination step 150 with a previously established reference list, and a step 220 of issuing an alert if the list of detected tools 1 is different from the reference list.

The alert is issued if the lists do not comprise the same tools 1. The alert may be visual, the indicator light 34 of the interface 3 being illuminated, possibly in red, for example. Alternatively, or additionally, the alert may be audible, a sound being emitted via the loudspeaker 36, for example.

The alert may alternatively be in the form of a message displayed on the screen 38 of the interface 3 in order to simply indicate that the list of detected tools 1 is different from the reference list, or to specify if the list of detected tools 1 comprises fewer tools 1, more tools 1 or different tools 1 than the reference list. This message may also indicate the reference of each missing and/or surplus tool 1.

The operator may possibly check that no tool 1 is positioned under or in another tool 1, and therefore not visible or identifiable, optionally moving the tools and restarting the method by means of a control button 31, 32, if required. The newly determined list of tools is then taken into account, the list of tools that triggered the alert being cancelled or deleted from the memory 23, as the case may be.

The method may also comprise a step 225 of displaying a piece of information relating to this comparison when the established list is identical to the reference list. This display of information may, for example, be in the form of the indicator light 33 being illuminated, for example in green, or a specific message being displayed on the screen 38.

The method may also comprise checking the mass to ensure that the determined list of tools 1 present in the checking area 25 is correct. To this end, the method for identifying tools according to the disclosure comprises the following steps:

measuring 230 a first mass of the at least one tool 1 positioned in the checking area 25 by means of the scales 28;

calculating 240 a second mass equal to the sum of the theoretical masses of the tools 1 present in the list with the calculator 22;

comparing 250 the first mass and the second mass with the calculator 22; and

issuing 260 an alert if a difference between the first mass and the second mass is greater than a predetermined threshold.

A difference between the first mass and the second mass may be greater than the predetermined threshold, for example, when at least one tool has not been identified or has been identified incorrectly during the identification step 140, a symbol perhaps being partially or completely concealed by another tool or indeed partially or completely damaged or erased or covered by a foreign body.

As previously, the alert may be visual, the indicator light 34 of the interface 3 being illuminated in red, for example, and/or audible, a sound being emitted via the loudspeaker 36, for example. The alert may alternatively be in the form of a message displayed on the screen 38 of the interface 3 in order to simply indicate that the mass of the tools 1 present in the checking area 25 is different from the theoretical mass corresponding to the list of detected tools 1, or to specify the discrepancy in mass between the first and the second masses.

The method may also comprise a step 265 of displaying a piece of information relating to the comparison between the first and second masses. This display of information may be in the form, for example, of the green indicator light 33 being illuminated or a specific message being displayed the screen 38 when the difference between them is less than or equal to the predetermined threshold.

Moreover, when the tools 1 are positioned in the checking area 25 in a storage box 18, the storage box should also comprise a marking area provided with at least one symbol in order for the method to identify the storage box 15, a theoretical mass of the storage box 18 then being associated with the symbol 15 provided on this storage box 18.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for identifying tools, the tools comprising a marking provided with at least one optically readable symbol,
the method comprising the following steps:
positioning several tools in a checking area;
capturing at least one image of the checking area by means of at least one image capture device, the image capture device(s) covering the checking area;
detecting at least one complete symbol situated in the image(s) by means of an image processing operation carried out by a calculator;
identifying, with the calculator, at least one detected tool corresponding to the complete symbol(s) detected during the detection; and
determining a list comprising the detected tool(s),
wherein the symbol comprises a barcode or a matrix code allowing each tool to be identified individually and uniquely, the marking covering 360° in a peripheral region of the tool.

2. The method according to claim 1,
wherein the method comprises a step of recording the list in a memory.

3. The method according to claim 1,
wherein the method comprises the following steps:
comparing, with the calculator, the list with a previously established reference list; and
issuing an alert if the list of the detected tools is different from the reference list.

4. The method according to claim 1,
wherein the method comprises the following steps:
measuring a first mass of the tool(s) positioned in the checking area by means of scales;
calculating a second mass equal to the sum of the theoretical masses of the tools present in the list with the calculator, each tool being associated with a theoretical mass;
comparing the first mass and the second mass; and
issuing an alert if a difference between the first mass and the second mass is greater than a predetermined threshold.

5. The method according to claim 1,
wherein the method comprises a step of illuminating the checking area.

6. The method according to claim 1,
wherein at least two image capture devices together cover the checking area, each image capture device covering a capture area, the checking area being equal to the surface area covered together by the capture areas of the at least two image capture devices, and the capture areas of the at least two image capture devices have an overlap area with a width greater than or equal to the largest dimension of a symbol.

7. The method according to claim 1,
wherein the marking comprises several identical symbols in the peripheral region.

8. The method according to claim 1,
wherein the marking comprises a single unidirectional symbol imprinted continuously in the peripheral region.

9. The method according to claim 1,
wherein, the peripheral region comprising several faces, at least one symbol is imprinted on each face.

10. A system for identifying tools comprising:
at least one image capture device, the image capture device(s) covering a checking area;
a calculator; and
tools,
wherein the symbol comprises a barcode or a matrix code allowing each tool to be identified individually and uniquely, the marking being arranged on each tool over 360° in a peripheral region of the tool, the system being configured to implement the method for identifying tools according to claim 1.

11. The system for identifying tools according to claim 10,
wherein the system comprises an illumination device positioned between the image capture device(s) and the checking area, the illumination device comprising one or more light sources.

12. The system for identifying tools according to claim 10,
wherein the system comprises scales fitted with a weighing pan, the checking area being situated on the weighing pan.

13. The system for identifying tools according to claim 10,
wherein the marking comprises several identical symbols in the peripheral region.

14. The system for identifying tools according to claim 10,
wherein the marking comprises a single unidirectional symbol imprinted continuously in the peripheral region.

15. The system for identifying tools according to claim 10,
wherein the peripheral region comprises several faces and each face comprises at least one symbol.

16. The system for identifying tools according to claim 10,
wherein the marking comprises at least two rows of symbols.
